(19) United States
(12) Patent Application Publication
(10) Pub. No.: US 2018/0029106 A1
(43) Pub. Date: Feb. 1, 2018

(54) PROCESS FOR THE PRODUCTION OF CORES OF SILICA FOR COMPONENTS OF AERONAUTICAL AND INDUSTRIAL TURBINES

(71) Applicant: EUROPEA MICROFUSIONI AEROSPAZIALI S.P.A., Morra de Sanctis (IT)

(72) Inventors: Michele DI FOGGIA, Morra de Sanctis (IT); Pietro PENNELLA, Morra de Sanctis (IT); Beniamino LONGOBARDI, Morra de Sanctis (IT)

(21) Appl. No.: 15/548,722

(22) PCT Filed: Feb. 5, 2016
(86) PCT No.: PCT/IT2016/000029

§ 371 Date: Aug. 3, 2017

(30) Foreign Application Priority Data
Feb. 9, 2015 (IT) 102015000005767

(51) Int. Cl. B22C 1/00; C01B 33/12; B22C 9/10

(52) U.S. Cl. CPC B22C 1/00; B22C 9/10; C01B 33/12

(57) ABSTRACT

The present invention concerns a process for the production of cores of silica for aeronautical and industrial turbine components, comprising the following steps: manufacturing of a metal mother mold; manufacturing of a plaster mold by means of casting in the mother mold of a mixture of water and plaster and subsequent drying; casting in a cavity of said plaster mold of a mixture of silica and water; resting of the mixture of silica inside the plaster mold, with water absorption by the mold and solidification of a core of silica; extracting of the core of silica from the mold and air drying at a temperature not exceeding 50° C.; sintering of the core of silica; finishing and dimensional inspecting of the core. The invention additionally concerns a core for aeronautical and industrial turbine components characterised by the fact of being constituted of silica, i.e. totally free from alumina and/or zirconium silicates.

The present invention concerns a process for the production of cores of silica for aeronautical and industrial turbine components and the cores obtained through such process.

More in particular, the invention relates to a process for the production of cores of silica for aeronautical and industrial turbine components by casting in plaster molds.

It is known that the production of aeronautical and industrial turbines components provides for a process of melting and casting of metals and/or constituent alloys of these components within suitable molds

Cores are often inserted within these molds, i.e artefacts, mainly consisting of sintered amorphous silica, the function of which is to fill a part of the mold, to prevent it from being filled by the molten metal.

At present, the cores of silica are made by injection into steel molds of a mixture of ceramic powders, typically silica (80%), together with additives such as alumina and zirconium silicate (20%) as well as a binder, typically wax. To ensure correct filling of the mold, the injection is carried out at high temperatures, to give the mixture a certain fluidity, due to the action of the additive components of the mixture; and especially at high pressures, up to 200 bar. These pressure values require the use of steel molds with high costs of maintenance of the mold cavity. In fact, the steel molds for ceramic injection must be periodically subjected to nitriding processes of the internal cavity, which is slowly and inexorably abraded at the passage of the injections.

It follows a cost of realization and maintenance of the molds which proves to be very high and not justified in all those cases in which it was possible to take advantage of cheaper molds without compromising the quality of the obtained product, taking into account the requirements that such product must withstand.

From the above derives the need to develop a process for the production of cores of silica for aeronautical and industrial turbines components which allows to use cheaper molds, guaranteeing a performance equivalent to that of the processes according to the prior art in particular as regards the dimensional stability of the obtained product.

These and other results are obtained according to the present invention by proposing a process for the production of cores of silica for aeronautical and industrial turbines components by casting.

Purpose of the present invention is therefore to provide for a process for the production of cores of silica for aeronautical and industrial turbine components which allows to overcome the limitations of the processes according to the prior art and to obtain the previously described technical results.

A further object of the invention is that said process can be realized with low costs.

Another object of the invention is to provide for a process for the production of cores of silica for aeronautical and industrial turbines components that is simple, safe and reliable.

It is therefore a first specific object of the present invention a process for the production of cores of silica for aeronautical and industrial turbine components comprising the following steps:
manufacturing of a metal mother mold;
manufacturing of a plaster mold by means of casting in the mother mold of a mixture of water and plaster and subsequent drying;
casting in a cavity of said plaster mold of a mixture of silica and water;
resting of the mixture of silica inside the plaster mold, with water absorption by the mold and solidification of a core of silica;
extracting the core of silica from the mold and air drying at a temperature not exceeding 50° C.;
sintering the core of silica;
finishing and dimensional inspecting of the core.

In particular, according to the invention, the metal of said mother mold is chosen among aluminum, titanium, copper or steel, and is preferably aluminum.

Additionally, according to the invention, the water of said mixture of water and plaster is demineralised water.

Preferably, according to the invention, said mixture of water and plaster is made of 52%±0.5% by weight of plaster and 48%±0.5% by weight of water.

In particular, always according to the invention, said plaster mold is formed of at least two parts.

Moreover, according to the present invention, said casting in a cavity of said plaster mold of a mixture of silica and water takes place under conditions of controlled temperature and humidity, with temperature comprised in the range 18-22° C. and humidity comprised in the range 25-35%, and preferably at a temperature of 20° C. with humidity of 30%.

Additionally, according to the invention, said mixture of silica and water comprises silica with different granulometry, and the water of said mixture of silica and water is demineralised water, and preferably said mixture of silica and water is composed of 57% by weight of silica 44 μm, 4% by weight of silica 74 μm, 21% by weight of silica 150 μm and 18% by weight of demineralised water.

Preferably, always according to the invention, said step of drying the core of silica occurs at a temperature comprised among 45 and 50° C.

Moreover, it is a second specific object of the present invention a core for aeronautical and industrial turbine components characterised by the fact of being constituted of silica, i.e. totally deprived of alumina and/or zirconium silicates.

It is evident the effectiveness and the advantages of the process for the production of cores of silica for aeronautical and industrial turbine components of the present invention.

In fact, the process of casting does not require for operating at high pressure, removing the need for using steel molds and allowing their replacement with disposable plaster molds, which are very cheap.

Additionally, since no high pressure and/or temperature is required, it is possible not to use a binder in the mixture of ceramic powders used to make the cores, making it superfluous the use of alumina and zirconium silicate. In fact, the material used in the process of casting is only silica, added with water which is removed during the steps of the process, to obtain a core only made of silica, with undoubtful advanteges in terms of production costs, due to the fact of not using alumina and/or zirconium silicates.

The invention will be described in the following for illustrative, non limitative purposes, with particular reference to some illustrative examples, and to the figures of the encosed drawings, wherein:

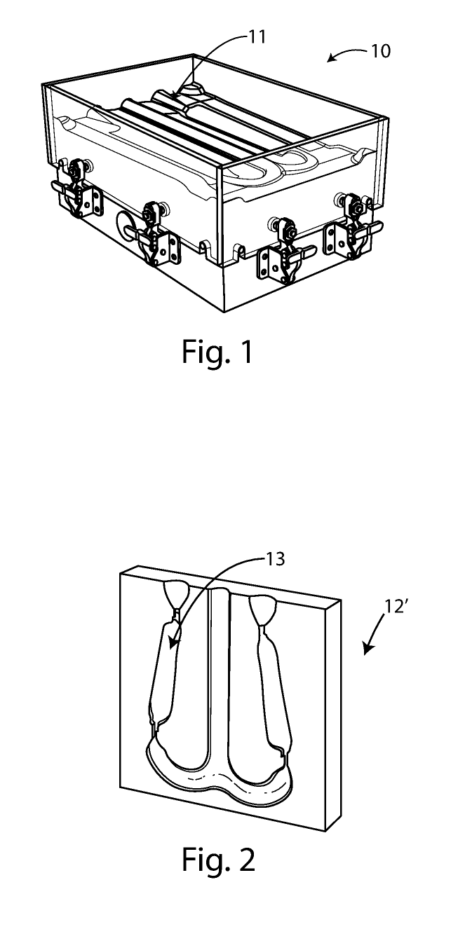

FIG. 1 shows a perspective view of a mother mold for the making of a part (half shell) of a plaster mold for the process according to the present invention,

FIG. 2 shows a perspective view of a part (half shell) of a plaster mold for the process according to the present invention,

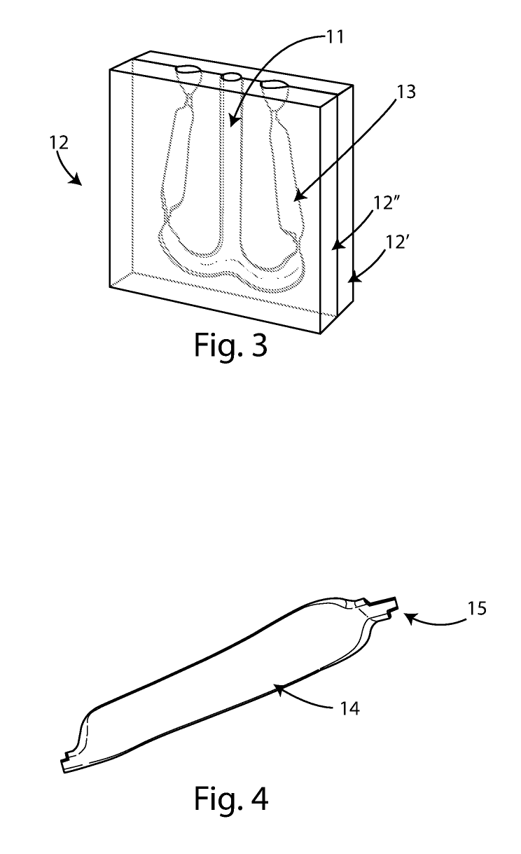

FIG. 3 shows a perspective view of a plaster mold for the process according to the present invention, and

FIG. 4 shows a perspective view of a core obtained through the process according to the present invention.

With reference to the figures, wherein the particular shape of the mold and the core have a purely illustrative and exemplifying and non limitative, the process can be schematically summed up as follows.

In a first step there is provided a mother mold 10 of metal (preferably aluminum, but also alternately titanium, copper or steel) for forming a first part (called half shell) of the plaster mold to be made. In the case in which this first part is not identical to that required for the realization of the second part of the plaster mold to be realized it will be also necessary to proceed in the same way for the realization of a second mother mold (not shown) complementary to the first. For the realization of the mother mold 10 the starting point is a mathematical model of the finished product obtained by applying the shrinkage factor associated with the manufacturing process of the core (and empirically determinable by a person skilled in the art), and adding all the appendices needed for the casting process of the mixture of silica in the plaster mold, i.e. the channels 11 for the feeding and the casting of the mixture of silica in the mold. Subsequently, it is created a three-dimensional model to be used for the construction (usually by molding) of the mother mold 10.

On the mother mold 10 it is then cast a mixture of plaster, which was previously obtained by mixing plaster and water, preferably mineralized water, according to percentage compositions in the range 52%±0.5% by weight of plaster and 48%±0.5% by weight of water, and preferably 52% by weight of plaster and 48% by weight of water. The preference for the use of demineralised water is due not only to the need to avoid phenomena such as the formation of scale, but also in that of having the most reproducible possible characteristics of the plasters in terms of ability to absorb water from the mixture of silica and water that will later be cast. It is obtained a first part 12′ (referred to as half shell) of the plaster mold to be made. A second part 12″ of the plaster mold to be made, complementary to the first, will be made in the same way.

The two parts (half-shells) of the mold are then coupled to form a cavity 13 inside which is then cast, up to filling of the cavity 13, the mixture of silica of the ceramic core, under conditions of controlled temperature and humidity, with temperature comprised in the range 18-22° C. and humidity comprised in the range 25-35% and preferably at a temperatures of 20° C. with humidity of 30%. The mixture of silica is formed by using powders of silica, preferably with different grain sizes, according to considerations to the reach of a person skilled in the art that have the purpose to avoid the formation of lumps. In the most preferred form the silica mixture is formed by three powders of silica with different particle size, respectively equal to 44, 74 and 150 μm, with demineralised water; in the following percentage composition by weight: 57% of silica 44 μm, 4% of silica 74 μm and 21% of silica 150 μm and 18% of demineralised water. By way of example, 300 kg of mixture of silica, with the following quantities: 171 kg of silica 44 μm, 12 kg of silica 74 μm, 63 kg of silica 150 μm and 54 kg of demineralised water, are needed to fill the plaster mold shown with reference to the figures.

After a predetermined amount of time (due to the geometry of the part to be produced) the mold 12 of plaster is opened and the ceramic core 14 is extracted. The waiting time is functional to obtain that the cast in plaster 12 can absorb water from the core 14, to obtain a solid core.

Once extracted, the core 14 is allowed to dry in air at a temperature not exceeding 50° C. and preferably at temperatures of 45-50° C. The duration of the step of drying is variable depending on the size and the form of the piece to be produced.

Finally, the core 14 thus formed is subjected to sintering and finishing, as well as to dimensional verification, as is already the case according to the known technology of preparation of cores by means of injection.

The sintering parameters change depending on the type of material used, according to considerations at the reach of a man skilled in the art.

In the case shown in the present description by way of example but not of limitation, the sintering is obtained at a temperature of 1175° C. for 3 hours in a natural gas oven, to give the core 14 adequate mechanical characteristics (e.g. MOR).

The finishing of the core 14, in addition to eliminate any surface imperfections, also serves to eliminate the appendices 15 due to the step of casting, i.e. that were formed for the permanence of a part of the mixture of silica in the channels 11 of casting.

The present invention has been described for illustrative but not limitative purposes, according to its preferred embodiments, but it is to be understood that variations and/or modifications may be made by those skilled in the art without departing from the relative scope of protection, as defined by the appended claims.

1. Process for the production of cores of silica for aeronautical and industrial turbine components, comprising the following steps:
manufacturing of a metal mother mold;
manufacturing of a plaster mold by means of casting in the mother mold of a mixture of water and plaster and subsequent drying;
casting in a cavity of said plaster mold of a mixture of silica and water;
resting of the mixture of silica inside the plaster mold with water absorption by the mold and solidification of a core of silica;
extracting of the core of silica from the mold and air drying at a temperature not exceeding a 50° C.;
sintering of the core of silica;
finishing and dimensional inspecting of the core.

2. Process for the production of cores of silica according to claim 1, characterised in that the metal of said mother mold is chosen among aluminum, titanium, copper or steel, and is preferably aluminum.

3. Process for the production of cores of silica according to claim 1, characterised in that the water of said mixture of water and plaster is demineralised water.

4. Process for the production of cores of silica according to claim 1, characterised in that said mixture of water and plaster is made of 52%±0.5% by weight of plaster and 48%±0.5% by weight of water.

5. Process for the production of cores of silica according to claim 1, characterised in that said plaster mold is formed from at least two parts.

6. Process for the production of cores of silica according to claim 1, characterised in that said casting in a cavity of said plaster mold of a mixture of silica and water takes place under conditions of controlled temperature and humidity, with temperatura comprised in the range 18-22° C. and and humidity comprised in the range 25-35%, and preferably at a temperature of 20° C. with humidity of 30%.

7. Process for the production of cores of silica according to claim 1, characterised in that said mixture of silica and water comprises silica with different granulometry.

8. Process for the production of cores of silica according to claim 1, characterised in that the water of said mixture of silica and water is demineralised water.

9. Process for the production of cores of silica according to claim 1, characterised in that said mixture of silica and water is composed of 57% by weight of silica 44 μm, 4% by weight of silica 74 μm, 21% by weight of silica 150 μm and 18% by weight of demineralised water.

10. Process for the production of cores of silica according to claim 1, characterised in that said step of drying the core of silica occurs at a temperature comprised among 45 and 50° C.

11. Core for aeronautical and industrial turbine components characterised by the fact of being constituted of silica.
